(19) United States
(12) Patent Application Publication
(10) Pub. No.: US 2025/0005656 A1
(43) Pub. Date: Jan. 2, 2025

(54) Uncertainty Informed Automatic Bidding

(71) Applicant: Google LLC, Mountain View, CA (US)

(72) Inventors: Alexander Kerelsky, New York, NY (US); Sergiu Ion Goschin, Mountain View, CA (US); Dong Lin, Mountain View, CA (US); Jie Han, San Jose, CA (US)

(21) Appl. No.: 18/658,397

(22) Filed: May 8, 2024

Related U.S. Application Data
(60) Provisional application No. 63/524,282, filed on Jun. 30, 2023.

(51) Int. Cl. G06Q 30/08

(52) U.S. Cl. CPC G06Q 30/08

(57) ABSTRACT

This technology generally relates to a method for leveraging a measure of bidding model uncertainty to directly improve automatic bidding. The methods may include measuring the inherent uncertainty of automatic bidding models using techniques, such as quantile regression. Further, the measure of bidding model uncertainty may be incorporated into bid formulas to inform the generated bids for an auction. The method may be further formulated to modify the bids to be more conservative when the bidding model uncertainty is higher. Once the uncertainty level of the bidding model is reduced to a more stable level, the bidding method will resume generating bids with more efficiency.

### CROSS-REFERENCE TO RELATED APPLICATIONS

This application claims the benefit of the filing date of U.S. Provisional Patent Application No. 63/524,282 filed Jun. 30, 2023, the disclosure of which is hereby incorporated herein by reference.

### BACKGROUND

Reserved space for content typically appears on a publisher's website or mobile application alongside organic search results when a user performs a search or browses a product category. When a user enters a search query, the publisher of the website may create an auction for reserved content space. The publisher may seek bids from content suppliers to fill the reserved content space. When generating the bids for the reserved content space, content suppliers often have to estimate the expected utility of the content for each auction and enter a bid proportional to the expected utility of the content. This is an inherently speculative estimate that may result in suboptimal bidding, such as bidding too high or too low for the reserved content space. Moreover, the speculative bidding is an inefficient use of the content supplier's and the publisher's resources.

### BRIEF SUMMARY

This technology generally relates to a method for leveraging a measure of bidding model uncertainty to directly improve automatic bidding. The methods may include measuring the inherent uncertainty of automatic bidding models using techniques, such as quantile regression. Further, the measure of bidding model uncertainty may be incorporated into bid formulas to inform the generated bids for an auction. The method may be further formulated to modify the bids to be more conservative when the bidding uncertainty is higher. Once the uncertainty level of the bidding model is reduced to a more stable level, the bidding method will resume generating bids less conservatively and with more efficiency.

One aspect of the disclosure relates to a method comprising receiving campaign information with one or more campaigns from at least one content supplier, wherein the campaigns are stored in a memory, wherein the campaign information includes a bid strategy, receiving a search query, in response to receiving the search query, generating an auction, wherein the auction is a request for bids for a reserved content space on the content page of a publisher, generating a plurality of bids based on the campaign information associated with one or more campaigns, wherein at least one of the bids calculated using an uncertainty measurement, selecting at least one of the campaigns based on the bid and causing the content associated with the selected campaign to be displayed at the reserved content space.

According to aspects of the disclosure, generating the plurality of bids may further comprise utilizing at least one bidding model, wherein the uncertainty measurement is based on historical information of the at least one bidding model. In some aspects of the disclosure, the uncertainty measurement may be calculated using quantile regression methods. In some aspects of the disclosure, the uncertainty measurement may be calculated using at least one of ensembles, dropout, and Bayesian methods. In some aspects of the disclosure, the uncertainty measurement is calculated using a trained neural network. The trained neural network may be trained using data from previous outcomes.

According to some aspects of the disclosure, receiving the plurality of bids may be further based on the search query, such that at least one bid for the auction is related to the search query. In some aspects of the disclosure, the method may further comprise providing feedback to the content supplier regarding the effectiveness of the bidding strategy for the campaign.

According to some aspects of the disclosure, the method may further comprise generating keywords associated with the subject of the search query and selecting one or more campaigns associated with the search query keywords. In some aspects of the disclosure, the search query is received from an end user. Further, selecting one of the campaigns may be based on historical interactions of the end user.

In some aspects of the disclosure, the method may further comprise determining a relative degree of the uncertainty measurement, wherein generating the plurality of bids on the relative degree of uncertainty measurement.

One aspect of the disclosure relates to a system comprising a memory storing one or more campaigns from a content suppliers, the campaigns having associated campaign information including a bidding strategy, one or more processors configured to receive a search query, in response to the search query, generate a request for bids for a reserved content space on a content page of a publisher, generate a plurality of bids based on the campaign information, wherein at least one of the bids is calculated using an uncertainty measurement, select at least one campaign based on the plurality of bids, and cause content associated with the selected campaign to be displayed at the reserved content space.

According to some aspects of the disclosure, the one or more processors may be further configured to utilize at least one bidding model, wherein the uncertainty measurement is based on historical information of at least one bidding model. In some aspects of the disclosure, the uncertainty measurement may be calculated using quantile regression methods. In some aspects of the disclosure, the uncertainty measurement is calculated using at least one of ensembles, dropout, and Bayesian methods. In some aspects of the disclosure, the uncertainty measurement may be calculated using a trained neural network. The trained neural network may be trained using data from previous outcomes.

According to some aspects of the disclosure, the system may generate the plurality of bids further based on the search query, such that at least one bid for the auction is related to the search query. In some aspects of the disclosure, the one or more processors may be further configured to provide feedback to the content supplier regarding the effectiveness of the bidding strategy. According to some examples, the feedback may comprise a metric of effectiveness of the bidding strategy for the selected at least one campaign.

According to some aspects of the disclosure, the one or more processors may be further configured to generate keywords associated with the subject of the search query and select one or more campaigns associated with the search query keywords. In some aspects of the disclosure, the search query is received from an end user, and selecting at least one of the campaigns is based on historical interactions of the end user. In some aspects of the disclosure, the one or more processors may be further configured to determine a relative degree of the uncertainty measurement, wherein generating the plurality of bids is based on the uncertainty measurement.

Another aspect of the disclosure relates to a computer-readable medium carrying instructions that, when executed by one or more processors, cause the one or more processors to carry out the method described above.

### BRIEF DESCRIPTION OF THE DRAWINGS

FIG. 1 is a pictorial diagram illustrating an example system according to aspects of the disclosure.

FIG. 2 is a functional diagram illustrating an example system according to aspects of the disclosure.

FIG. 3A is a screenshot illustrating an example arrangement of content output via a webpage according to aspects of the disclosure.

FIG. 3B is a screenshot illustrating an example arrangement of content output via a mobile application according to aspects of the disclosure.

FIG. 4 is a pictorial representation of available products according to aspects of the disclosure.

FIG. 5 is a screenshot illustrating an example user interface for creating a campaign according to aspects of the disclosure.

FIG. 6 is a pictorial representation of available products and respective bids ranked according to aspects of the disclosure.

FIG. 7 is a sequence diagram according to aspects of the disclosure.

FIG. 8 is a flow diagram illustrating an example system according to aspects of the disclosure.

### DETAILED DESCRIPTION

The technology generally relates to selection of content for publishing on a web page or mobile application. The selection of content may be performed through a bidding process, such as an auction. For example, a web page or mobile application of a publisher may include reserved space for content, such as advertisements. Different content suppliers, such as advertisers, may bid on the reserved space. In some instances, campaigns may be set up by the content suppliers, wherein the campaigns define parameters for automatic bidding on the reserved space. The bids may be generated using a bidding model that accounts for the potential utility of the reserved space to the content supplier. According to the present disclosure, such bids may be automatically adjusted based on uncertainty measurements of the bidding model.

The disclosed technology optimizes bids by quantifying and incorporating inherent uncertainty of bidding models to inform the bids generated for the auction. The method of measuring and utilizing the uncertainty measurements for bidding will help formalize a bidding optimization model. For example, the system may reduce the value of bids in proportion to a degree of uncertainty.

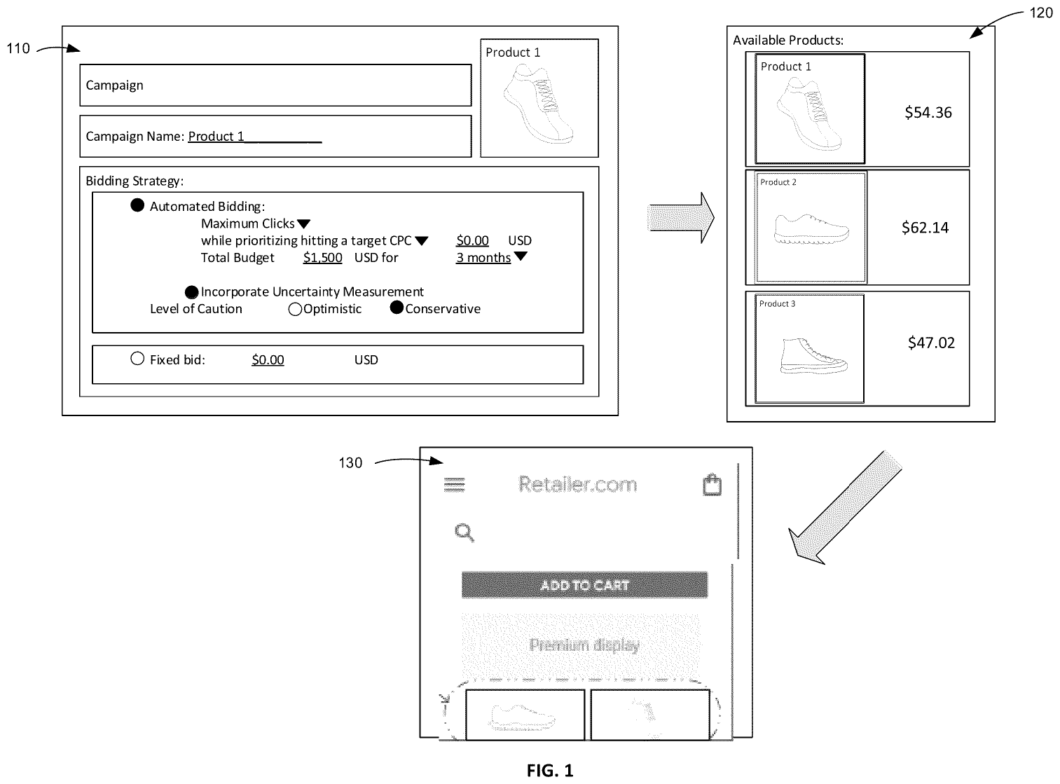

FIG. 1 illustrates an example bidding system including a user interface 110, a list of bids for available products 120, and a publisher's website 130. A content supplier may input campaign information into user interface 110. The content supplier may be, for example, an advertiser, manufacturer, retailer, service provider, etc. The content supplier may create campaigns for products or services to be displayed on the publisher's website 130. According to some examples, the campaigns may be for sponsored or featured products on the publisher's website 130. Each campaign may have one or more associated parameters. The parameters may define how bids are automatically placed, the bids relating to placement of content associated with the campaign at a reserved content space on the publisher's website 130.

The publisher may be, for example, a retailer or a search engine. The publisher may maintain a catalog of products or services offered by the publisher. According to some examples, the publisher may identify which products or services are available to be sponsored. For purposes of ease and clarity throughout the specification, products, services, messages, ideas, etc. may be collectively referred to as “products.”

According to some examples, the user interface 110 may be used for the content supplier to input campaign information for a campaign including campaign name, product images, bidding strategy, etc. The bidding strategy may include, for example, automated bidding, fixed bidding, goals of the campaign, total budget, length of the campaign, and desired level of caution. The campaigns may be for products, services, organizations, ideas, messages, etc. being offered by the content supplier, publisher, or retailer.

The campaign information may be used to generate bids for placing content associated with the campaign into a reserved content space. During an auction, multiple bids for reserved content space may be compiled and compared, as shown in the list of bids for available products 120. The bids may be ordered or ranked, for example, based on value, such as ranking from highest to lowest bid. The server may select which bids are accepted, such as based on the order or rank.

The selected bids may be displayed on the publisher's website 130. The publisher's website 130 may display content associated with the selected bids in reserved content spaces, such as alongside results to a user's query. In FIG. 1, the reserved content space is on the publisher's website 130 within the dotted lines.

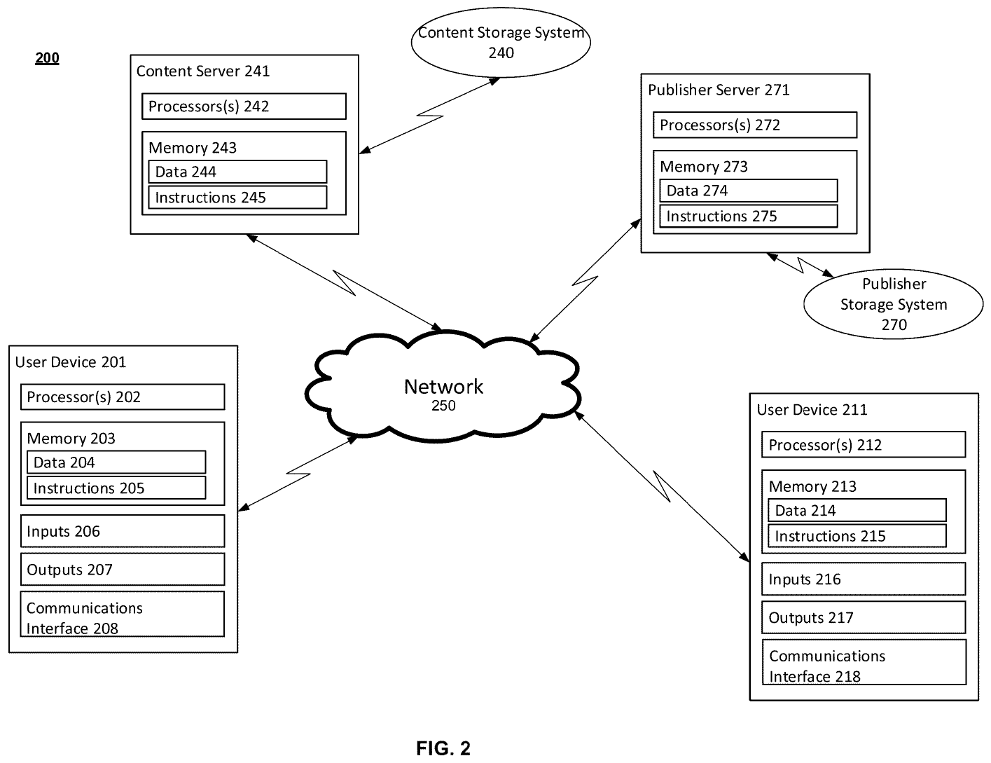

FIG. 2 illustrates an example system in which the features described above and herein may be implemented. It should not be considered as limiting the scope of the disclosure or usefulness of the features described herein. In this example, system 200 includes user devices 201, 211, content servers 241, content server storage system 240, publisher server 271, publisher storage system 270, and network 250. For purposes of clarity, devices 201, 211 will be described with respect to user device 201. However, it should be understood that device 211 may include the same or similar components and may function in substantially the same way.

User device 201 may include one or more processors 202, memory 203, data 204 and instructions 205. User device 201 may also include inputs 206, outputs 207, and a communications interface 208. The user devices 201 may be, for example, a smartphone, tablet, laptop, smartwatch, AR/VR headset, smart helmet, home assistant, etc.

Memory 203 of user device 201 may store information that is accessible by processor 202. Memory 203 may also include data that can be retrieved, manipulated, or stored by the processor 202. The memory 203 may be of any non-transitory type capable of storing information accessible by the processor 202, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 203 may store information that is accessible by the processors 202, including instructions 205 that may be executed by processors 202, and data 204.

Data 204 may be retrieved, stored, or modified by processors 202 in accordance with instructions 205. For instance, although the present disclosure is not limited by a particular data structure, the data 204 may be stored in computer registers, in a relational database as a table having a plurality of different fields and records, XML documents, or flat files. The data 204 may also be formatted in a computer-readable format such as, but not limited to, binary values, ASCII or Unicode. By further way of example only, the data 204 may comprise information sufficient to identify the relevant information, such as numbers, descriptive text, proprietary codes, pointers, references to data stored in other memories (including other network locations) or information that is used by a function to calculate the relevant data.

The instructions 205 can be any set of instructions to be executed directly, such as machine code, or indirectly, such as scripts, by the processor 202. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods, and routines of the instructions are explained in more detail below.

The one or more processors 202 may include any conventional processors, such as a commercially available CPU or microprocessor. Alternatively, the processor can be a dedicated component such as an ASIC or other hardware-based processor. Although not necessary, user device 201 may include specialized hardware components to perform specific computing functions faster or more efficiently.

Although FIG. 2 functionally illustrates the processor, memory, and other elements of user device 201 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of user device 201. Accordingly, references to a processor or user device will be understood to include references to a collection of processors or devices or memories that may or may not operate in parallel.

The inputs 206 may be, for example, a mouse, keyboard, touchscreen, microphone, or any other type of input. The inputs may receive keywords for a search on a publisher's website or mobile application.

Output 207 may be a display, such as a monitor having a screen, a touchscreen, a projector, or a television. The display 207 of the user device 201 may electronically display information to a user via a graphical user interface (“GUI”) or other types of user interfaces. For example, display 207 may electronically display product information and sponsored content on a publisher's website or mobile application.

The user devices 201 can be at various nodes of a network 250 and capable of directly and indirectly communicating with other nodes of network 250. Although two user devices are depicted in FIG. 2, it should be appreciated that a typical system can include one or more computing devices, with each computing device being at a different node of network 250. The network 250 and intervening nodes described herein can be interconnected using various protocols and systems, such that the network can be part of the Internet, World Wide Web, specific intranets, wide area networks, or local networks. The network 250 can utilize standard communications protocols, such as Wi-Fi, Bluetooth, 4G, 5G, etc., that are proprietary to one or more companies. Although certain advantages are obtained when information is transmitted or received as noted above, other aspects of the subject matter described herein are not limited to any particular manner of transmission.

System 200 may include one or more server computing devices, such as content server 241 and publisher server 271. The server computing devices may be, for example, a load balanced server farm, that exchange information with different nodes of a network for the purpose of receiving, processing, and transmitting the data to and from other computing devices. For instance, content server 241 and publisher server 271 may be a web server that is capable of communicating with the user device 201 via the network 250. In addition, content server 241 and publisher server 271 may use network 250 to transmit and present information to a user of user device 201. Content server 241 and publisher server 271 may include one or more processors 242, 272, memory 243, 273, data 244, 274, instructions 245, 275, etc. These components operate in the same or similar fashion as those described above with respect to user device 201.

Content server 241 may manage content, such as sponsored ads, and provide various services to the content suppliers, publishers, and devices 201. According to some examples, content server 241 may receive campaigns from one or more content suppliers. The campaigns may include campaign information, such as the products to be sponsored, bidding strategy, targeting information, duration, etc. The campaigns may be stored in the memory 243 of content server 241 and/or in content server storage 240.

Content server 241 may store historical records of campaigns and auctions in the memory 243 and/or in content server storage system 240. The historical records may include information regarding the uncertainty levels of the bidding models, the submitted bids, outcomes, and success rates of the bids at auction. The outcomes may include the outcome of publishing the selected content in the reserved content space, such as measuring interactions with an advertisement or other content placed in the content space.

According to some examples, publisher server 271 may receive a search query from user device 201. For example, the search query may be for specific content, such as product information. In response to the request, publisher server 271 may retrieve relevant content from publisher storage system 270. The publisher server 271 may transmit a content page or other presentation, representation, or characterization of the content to the requesting user device 201. The content page may include, for example, reserved content space.

According to some examples, in response to the received search query, publisher server 271 may transmit a request to content server 241. Content server 241 may facilitate the identification of relevant content for distribution to the publishers. The content server 241 may identify available products for the publisher. The content server 241 may identify relevant available products based on the search query. For example, the content server 241 may match the available products to the generated keywords from the search query. Content suppliers of the available products may bid on the reserved content space with their campaigns to have content associated with their campaign provided on the content page transmitted to user device 201 from publisher server 271. The content server 241 may automatically generate bids for the campaigns based on campaign information input by the content suppliers. The content server may rank or sort content from various campaigns based on respective bids and may select content from one or more campaigns to be published in the reserved content space.

User device 201 may present in a viewer, such as a browser, mobile application, or other content display system, the search query results integrated with the selected content published in the reserved content space.

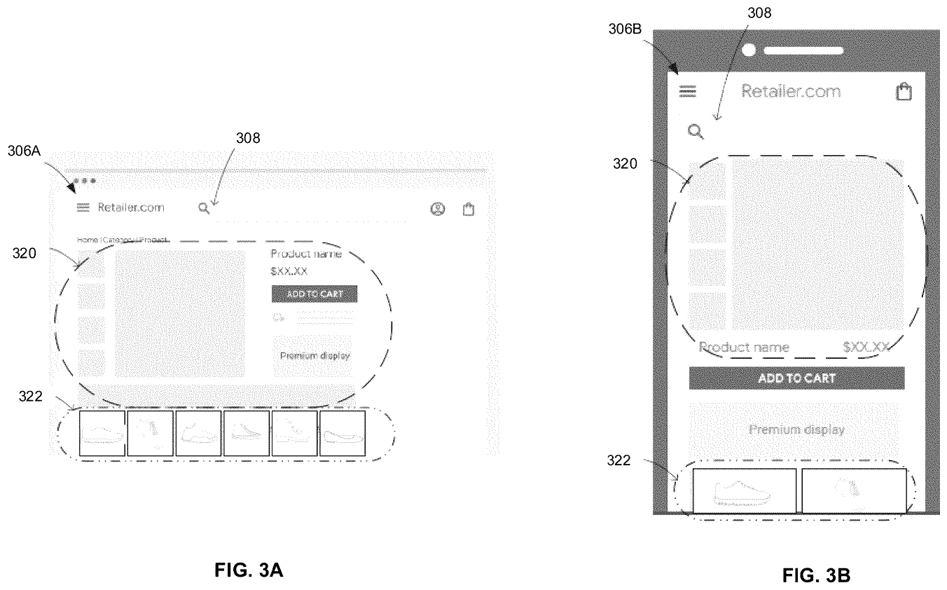

FIGS. 3A and 3B are screenshots of a publisher's website and publisher's mobile application, respectively, illustrating an example arrangement of content. The content may be provided in response to a user search query or content filter. The content may include, for example, details for one or more products 320, identification of related products, sponsored content, etc. The publisher may be, for example, a retailer offering products for consumption by users.

The publisher's website 306A and/or the publisher's mobile application 306B may include a search field 308. A user may enter a search query into search field 308 to search a publisher's catalog of offered products. The search query may be directed to a specific subject or product and include search terms, such as a product name or type. For example, a user may submit a query relating to “pink gym shoes.” To determine one or more campaigns to transmit to the publisher, the content server may identify available products or services being offered by multiple content suppliers.

Reserved content space may be for content that a content supplier has bid to have displayed on the publisher's website. By way of example only, the content supplier may be an advertiser that has set up a content campaign, wherein information in the campaign information is used to generate bids for placing content in a reserved space for sponsored content. As another example, the content supplier may be an image or video creator that generates a campaign to automatically bid on placing creative works on a web page. It should be understood that various other applications are possible. Reserved content space may enable the content supplier to cater to a receptive user by identifying content relevant to the user's query. The content server may match available products or services to the user's query. In some examples, the user's query or content filter may be used to automatically identify associated products and services to the user's query or content filter using language processing to identify keywords related to the user's query or content filter. In some examples, historical interactions of the user with respect to content published in response to historical queries may be used to identify campaigns to be included in the auction.

In response to receiving the search query, the publisher may transmit a request to the content server for content to be published in reserved space 322. The request may include the search terms of the search query. The content server may identify relevant content based on the search terms of the search query. For example, the content server may generate synonyms, or keywords, for the search terms. The content server generated keywords may be used to identify relevant available products offered by the retailer.

The content server may solicit bids from campaigns submitted by content suppliers in an auction. The content server may select the campaign with the winning bid. The selected campaign may be transmitted to the retailer to be published in the reserved space 322, such as alongside the search results from the search query.

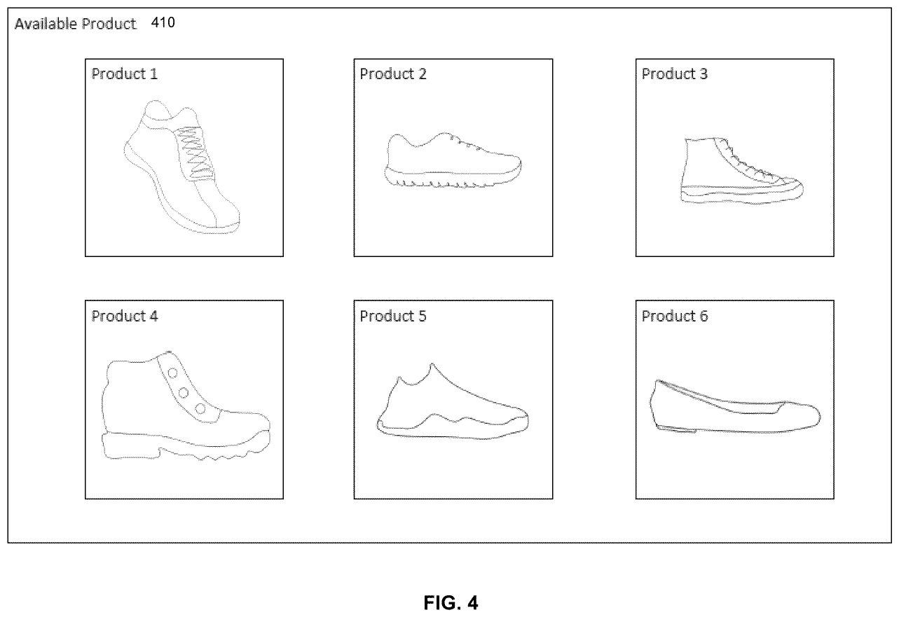

FIG. 4 illustrates an example set of products that can be displayed on the publisher's website or mobile application as content in reserved content spaces. The content server may identify one or more available products 410 to be provided as output in response to the request. According to some examples, the content server may identify available products 410 based on the subject of the request. For example, based on the search itself, e.g., “pink gym shoes”, and/or content server generated keywords for “pink gym shoes,” the content server may identify, at least, Products 1-6. While only Products 1-6 are shown as available products 410 that match the search query, more than six products may be identified.

According to some examples, the content server may identify available products 410 using an artificial intelligence (“AI”) model, such as a machine learning (“ML”) model. The AI model may compare the available product to one or more training models to determine whether the available product corresponds to what users associate with the query terms. The input features to the ML model may include the user's historical interactions with products and search terms. For example, if a user search query was for “shoes” and users typically selected “sneakers” in response to previous search queries, the ML model may be trained to identify available products related to “sneakers” over other available shoes, such as “boots.”

According to some examples, the content server may identify available products 410 based on the search history of the user. For example, the content server may identify available products associated with “pink gym shoes” because the user recently researched the topic within the publisher's website. In some examples, the content server may identify available products 410 based on what the user associates with the terms of the search query. User interactions between products and search terms may be based on previous user activity. Previous user activity may include, for example, clicks or selections of links, content, products, etc. in response to previous search queries.

While Products 1-6 are shown as tiles, the matching products may be shown in a list, as icons, etc., and may include additional details, such as the brand and/or product name, product details, content identifier, etc.

Each Product 1-6 may be associated with a respective campaign. The content suppliers may have created each campaign with information regarding a bidding strategy to be implemented in response to a search query.

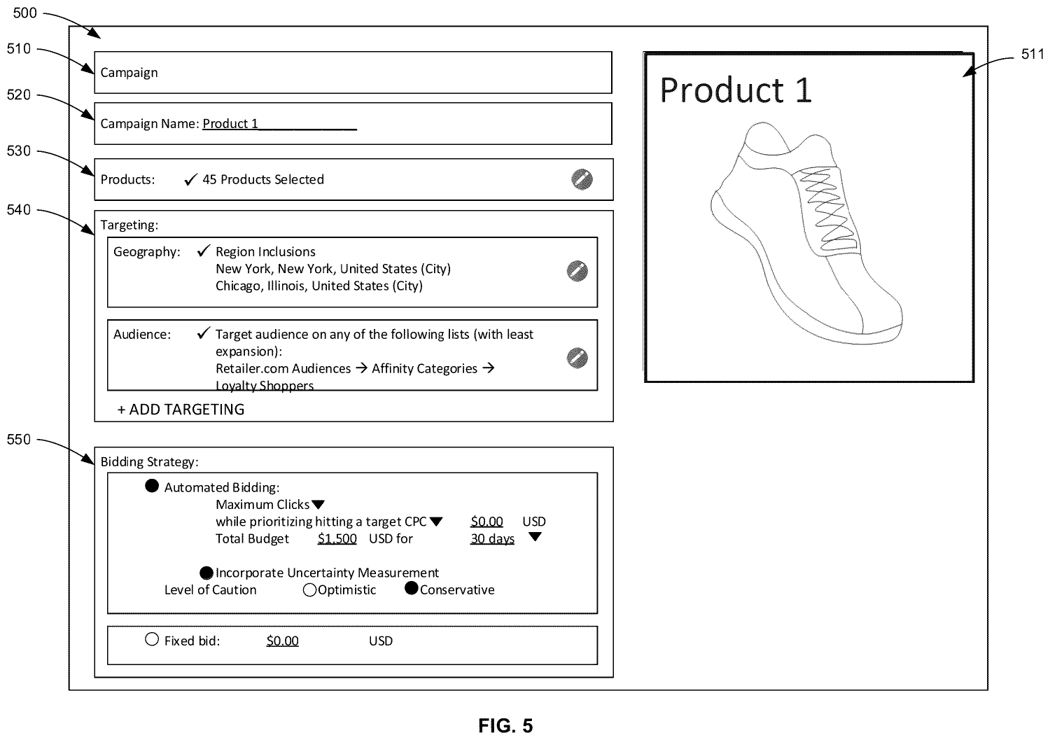

FIG. 5 is a screenshot illustrating an example user interface to be used by content suppliers for creating campaigns. The user interface 500 may include one or more input fields. The input fields may be configured to receive details relating to the campaign 510. As shown, the input fields included are related to product image 511, campaign name 520, products 530, targeting 540, and bid strategy 550. The interface 500 may include additional input fields not shown, such as campaign duration, publisher information, budgets, etc.

The campaign name 520 may allow for the content supplier to name the campaign. The name of the campaign may be used when the content server identifies relevant content to be output by the publisher. In some examples, the campaign name 520 may be used internally by the publisher to track previous and active campaigns. The content supplier may enter information into the campaign name 520 field. The system may receive the campaign name via inputs from a keyboard, microphone, touchscreen, etc.

The products 530 may be products that the content supplier selected to include in one or more campaigns, such as sponsored products depicted in content associated with the campaign. The products 530 may be entered by the content supplier and/or selected from a merchant's product catalog. The merchant may, in some examples, correspond to the publisher.

In some examples, the campaign may include targeting options 540, such as a relevant geographic region for the campaign, a target audience, etc. Additionally, or alternatively, the campaign may include a start date and an end date.

According to some examples, the campaign may include bid strategy 550. For example, the campaign may define a cost per selection, a maximum cost per selection, a cost per conversion, a maximum cost per conversion, etc. In some examples, the campaign information may include a set maximum bid or a maximum incremental bid for a given product. The maximum bid or increments may correspond to the amount per click the advertiser is willing to pay for the given product. The products may, therefore, be ranked based on content suppliers' willingness to pay per click for the product.

In some examples, several bid strategy options may be presented to the content supplier. Bid strategy options may include a maximum monetary value the content supplier is willing to pay for the reserved space, setting a 30-day budget for a campaign to manage which bids will get the most exposure in reserved space, and setting a target bid for each of the content supplier's keywords or search groups.

In some examples, the content supplier may be presented with an option to optimize the bids based on uncertainty measurements of the bidding models. For example, the bidding models may be evaluated orthogonally to evaluate the uncertainty associated with the model. The uncertainty may be evaluated based on a variance within one campaign to a performance of each predictor, e.g., quantile regression, dropout, or the like. The resources required for the model are evaluated to determine the resource that best captures the variance while also being feasible in view of any resource constraints. The uncertainty measurements, e.g., variances, may be incorporated into a content supplier's campaign strategy. For example, when the content supplier provides an input corresponding to a selection to incorporate uncertainty measurements as part of their bidding strategy, the content supplier's bid is further calculated using the uncertainty measurements from the bidding model used to generate their bids. This process is described in more detail below.

The content server may receive the campaigns from the content supplier. The content server may receive a request from a publisher for one or more campaigns to be displayed alongside the search results of a search query received by the publisher's website. The content server may solicit bids to an auction for the reserved content space.

As compared to previous auction bidding methods, the bids may be generated in response to this solicitation may use one or more bidding models. These bidding models may include uncertainty as to their accuracy for each request. The uncertainty of the bidding models may be determined and used to adjust a bidding strategy for a content supplier. Bidding uniformly entails bidding in proportion to the expected success of the bid for each auction. Determining the expected success is an estimation process that comes along with potential uncertainties. As with any estimation formula, there are uncertainties inherent to the estimation model due to inaccuracies. The inaccuracies may, in some part, be caused due to uncertainty within the model parameters or other natural causes, such as not all relevant causal features are present in the model, the model itself might not have enough capacity, generalization impact, etc. This uncertainty can be determined and used to increase the accuracy of the bidding model and overall system performance.

The system performance may be determined based on cost per action (CPA), return on spend (ROS), conversions, conversion value, or the like. In some examples, such as when the content supplier is an advertiser, the ROS may be a return on advertiser spend (ROAS). In some examples, the uncertainty is leveraged such that content suppliers receive more volume at their target CPA and/or ROS. In another example, the uncertainty is leveraged such that the content suppliers received more conversions and/or conversion value based on the content supplier budget set in their campaign. The uncertainty allows for improved system performance on uncertain traffic. Uncertain traffic includes, for example, sparser traffic where the model has had less of a chance to learn, e.g., unknown users, clicks, conversions, visits, etc. The determination of the uncertainty and the use of uncertainty as part of the bidding model allows for global optimization, as compared to a strict accuracy improvement in the model. In some examples, the use of uncertainty in the bidding model improves the model bias.

As an example, without determining and using uncertainty in the model, the bid in an auction may be determined using the following:

$$Bid = F ( pConvs , CPA \vert ROS )$$

“pConvs” corresponds to predicted conversions. When determining and including uncertainties in the bidding model, the bid in an auction may be determined using the following:

$$Bid = F ( pConvs , pConvsQX , pConvsQY , CPA \vert ROS )$$

In the above, “pConvsQX” corresponds to a predicted conversion for quantile X and “pConvsQY” corresponds to a predicted conversion for quantile Y. According to some examples, quantile X is less than quantile Y. Additional factors may be considered when determining the bid, with or without the uncertainty. The quantiles, e.g., regression quantiles, are used as a measure of uncertainty to modulate the bids. The modulation can occur as a combination for lowering or increasing bids.

In some examples, the determined uncertainty can be used to adjust bids in an auction based on a bidding strategy of a content supplier. For example, when the bidding model is determined to be uncertain, the resulting bid is more conservative as compared to when the bidding model is determined to be more certain, such that the resulting bid for the campaign is more aggressive. In such an example, the uncertainty may correspond to a likelihood of success associated with the content of the campaign. For example, a greater uncertainty associated with the bidding model may correspond to a lower likelihood of success whereas a lower uncertainty may correspond to a greater likelihood of success. The likelihood of success may be, for example, the likelihood of winning the auction, the likelihood of conversions based on a winning bid, or the like.

In some examples, based on the uncertainty of the bidding model, the bids at auction may be adjusted in proportion to the uncertainty of the bidding model, thereby balancing any potential revenue and losses associated with the bidding with more certain predictions. According to some examples, by informing a bidding strategy of a campaign based on the uncertainty associated with the bidding model, bids can be adjusted easily, effectively, and instantly.

In some examples, a content supplier may generate a campaign using uncertainty for exploration. Using uncertainty for exploration may include, for example, increasing bids instead of lowering bids in an effort to train the model and bidding system. For example, with very uncertain traffic, the model may bid too low to ever surface. However, within the very uncertain traffic, there may be good traffic for the content supplier. Good traffic may correspond to traffic of consumers or users that the content supplier is targeting. If the content supplier employs exploration as part of their campaign, the bids for the content supplier would increase proportional to the uncertainty. In some examples, the content supplier may experience lower performance for some period of time during the campaign but, in return, the content supplier may experience an increase in clicks and/or conversions. The increase in clicks and/or conversions may occur at a lower CPA and/or ROS. The clicks and/or conversions for the digital content of the campaign is used as feedback to update the model which of the uncertain traffic is good, e.g., leads to clicks and/or conversions, and bad, e.g., does not lead to clicks and/or conversions. As the model learns from the identified good and bad traffic, the uncertainty of the traffic may decrease.

The content supplier can, at any point during the campaign, disable exploration such that the campaign returns to the CPA and/or ROS set by the content supplier. As the model has been updated based on the determination of good and bad traffic when exploration was enabled, the model can leverage the identified good traffic when bidding.

For conversion-based bidding, the expected success is the expected number of conversions. Hence, for the standard bidding algorithm to perform as expected, a “perfect” oracle for predicting expected conversions is necessary. But a limited number of samples, amongst other reasons, inherently limits the ability to find such an oracle. In practice, the estimator model may build estimators for the expected number of conversions using deep neural networks (“DNNs”). Since an estimator can under or over-predict the true value of the expectation by a significant margin when the effective number of samples used to compute the prediction is small, the estimation models risk losing opportunities for increased volume due to underestimation or, conversely, achieve lower overall return on investment (“ROI”) when the model overestimates the value. A measure of estimator uncertainty may be used in developing bidding strategies to improve an accuracy of predicting expected conversions.

An uncertainty measurement for a bidding model is determined. The uncertainty measurement may, in some examples, correspond to an approximate representation of the estimator distribution. The estimator distribution may, in some examples, be a variance in the bidding model that impacts the model's performance. For example, the estimator can under or over-predict the true value of the expectation by a given margin. The representation of the estimator distribution, e.g., the uncertainty, can be used to correct for these under or over-predictions. For example, after the uncertainty measurement is determined, the uncertainty measurement is incorporated in calculating the bid.

The uncertainty of the bidding model(s) may be quantified in any of a variety of ways using neural networks. In some examples, the uncertainty of the bidding model may be determined using estimator approaches, such as quantile regression, ensembles, dropout, Bayesian methods, amongst others. These approaches may be used with campaigns that have previously been submitted for reserved content space and for campaigns that have yet to be submitted for reserved content space.

For campaigns for which bids have previously been generated, the estimator may use historical data of previous bids to determine the uncertainty measurement. The historical data may include outcomes, the success of the bid at auction, such as the price of the bid, the subsequent ranking the bid received in the auction, whether or not the bid won the auction, etc. The outcomes may include the outcome of publishing the selected content in the reserved space for content, such as measuring interactions with an advertisement or other content placed in the reserved content space. The historical data may be stored in the content server's memory or in the ad storage system. The content server may use this data to generate an uncertainty measurement for each campaign based on this historical data. In some examples, the uncertainty measurement may be stored in the content server memory. In some examples, the uncertainty measurement for a campaign may be recalculated for each bid.

For campaigns that have not had bids previously generated, the estimator may utilize historical data from similar campaigns to inform the uncertainty measurement. Similar historical data, as described above, may be used to determine the uncertainty measurement for the campaigns without a bidding history. The content server may determine campaigns are similar based on related campaign information such as selected products, target geographic regions, target audience, bidding strategies, budgets, time frames, and level of caution. The more campaign information the campaigns have in common, the more similar the campaigns are determined to be. In some examples, the content server may entirely use historical information from one or more similar content campaigns. In some examples, the content server may supplement historical data from a newer campaign with less historical information regarding bidding with historical information from one or more similar campaigns.

According to some examples, the technology may orthogonally evaluate the bidding model uncertainty. The system may compare the uncertainty measurements of one content supplier's campaign calculated by each estimator, such as quantile regression or dropout, described more fully below. Each estimator model may be evaluated to determine how resource heavy each estimator model is and a user or the system may choose the one that best captures the uncertainty while being feasible given any resource constraints.

According to some examples, the method may utilize quantile regression to quantify the uncertainty measurement of the bidding predictions. While least squares regression estimates the mean of a distribution, quantile regression is an alternative which estimates the median and/or quantiles. Quantile regression can be used for simple linear modeling but also various other modeling strategies such as deep learning. Using the quantile regression loss function with gradient descent allows simple extension to neural networks.

Quantile regression as an uncertainty modeling technique for DNN is lightweight resource wise, fairly generic to the main network's architecture and may predict distributions and not just point estimates of uncertainty. The use of quantile regression may use less computational resources of the content server when generating the uncertainty model, as compared to other estimator approaches. As such, using quantile regression to determine the uncertainty measurement of the bidding models provides a quicker, less computationally intensive, and more user-friendly experience in bidding as compared to other methods.

In some examples, the method may utilize ensemble-based estimation to quantify the uncertainty measurement of the predictions.

In some examples, the method may utilize dropout estimation to quantify the uncertainty measurement. Similar to quantile regression, dropout utilizes a neural network with multiple layers to quantify large amounts of data. This data may be collected during specific time periods, such as several days, weeks, months, etc. The layers of the neural network may be divided into main layers and sub-layers. A sub-layer may be attached to a portion of the main layer. Based on a predetermined dropout rate, dropout randomly disables neurons in the sub-layer. To determine the uncertainty measurement, repetitive estimations or predictions are run with the dropout turned on. The standard deviation of the log outputs from the sample estimations or predictions is treated as the uncertainty score.

According to aspects of the disclosure, the system may leverage the determined uncertainty measurement to directly improve automatic bidding based on the content supplier's preferences for bidding. For example, the system may reduce bids in proportion to uncertainty measurement with the intention of rebalancing the content supplier's revenue with more certain predictions. In another example, the method may increase bids for less certain traffic with an explore-exploit approach—boosting bids to gain more information, therefore, tightening prediction uncertainty bounds, and predicting more accurately.

According to some examples, the bidding may occur automatically based on the bid strategy included in the campaign. For example, the campaign may define a cost per selection, a maximum cost per selection, a cost per conversion, a maximum cost per conversion, etc. In some examples, the campaign may include targeting options, such as a relevant geographic region for the campaign, a target audience, etc. According to some examples, the method may leverage machine learning model changes to measure uncertainty of the bidding models.

In some examples, the method may adjust predicted conversions term, or modify a prior, to balance between the prior and predicted conversions based on the uncertainty measurement. In the latter scenario, the prior may weigh more heavily in the formula in what is determined to be a high level of uncertainty and, inversely, may be less of a factor when the uncertainty level is low.

As shown in FIG. 5, the user interface 500 may give the content supplier the option to select a “level of caution” the content supplier would like to employ when generating the bids for the campaign 510. The “level of caution” option may be included under bidding strategy 550 options. In some examples, the content supplier may select “conservative” as the desired level of caution and the content server may encode inherent “pessimism” based on the uncertainty measurement. For example, the bid would be significantly lowered for very uncertain predictions while relatively unchanged for certain predictions, thus transferring revenue to more confident prediction bids. In some examples, the content supplier may select “optimistic” as the desired level of caution and the content server may encode inherent “optimism” based on the uncertainty measurement. For example, the bid would be significantly higher for uncertain predictions while relatively unchanged for certain predictions, thus transferring revenue to more risky prediction bids. In some examples, the content supplier may opt to have the system automatically adjust the bids. There may be an option for an “auto” level of caution wherein the content server automatically determines whether to adjust the bids based on the uncertainty measurement.

Further, the content server may modify the generated bids to be more conservative when the bidding model uncertainty is relatively high. This function may be associated with the content supplier's input for the campaign information. For example, the content supplier may select conservative as the level of caution for the campaign. The content server will take that into account and may generate more conservative bids when the bidding model uncertainty is determined to be high.

Content server may store historical information of a campaign's bids and auctions in the content server's memory. The historical information may include information regarding the uncertainty levels of the bidding models, the submitted bids, and success rates of the bids at auction. In some examples, the content server may use the historical information to determine the bidding model uncertainty measurement is high based on a comparison to similar bids that have been submitted in other auctions over a set period of time. In some examples, the content server may determine the bidding model uncertainty measurement is high based on a threshold. This threshold may be proportional to similar bids in other auctions over a set period of time or based on a set percentile determined by the publisher, content supplier, or content server. Once the uncertainty level of the bidding model is reduced to a more stable level, the bidding method will resume generating bids with more efficiency. By taking the bidding model uncertainty into account when generating the bids, the bidding system is better suited for stabilizing performance the short-term needs of the content supplier in bidding and for ensuring optimized performance of the campaign to enable the traffic of the campaign to expand to larger audiences.

According to some examples, a content server may solicit bids in an auction from available campaigns, such as campaigns associated with content or products that match the search query or are related to the search query. The available campaigns may include content or products that are most relevant to the user search query received by the publisher's website or mobile application. The available campaigns may each include parameters for automatic bidding, and therefore soliciting the bids may result in bids being automatically generated based on the parameters in each respective available campaign.

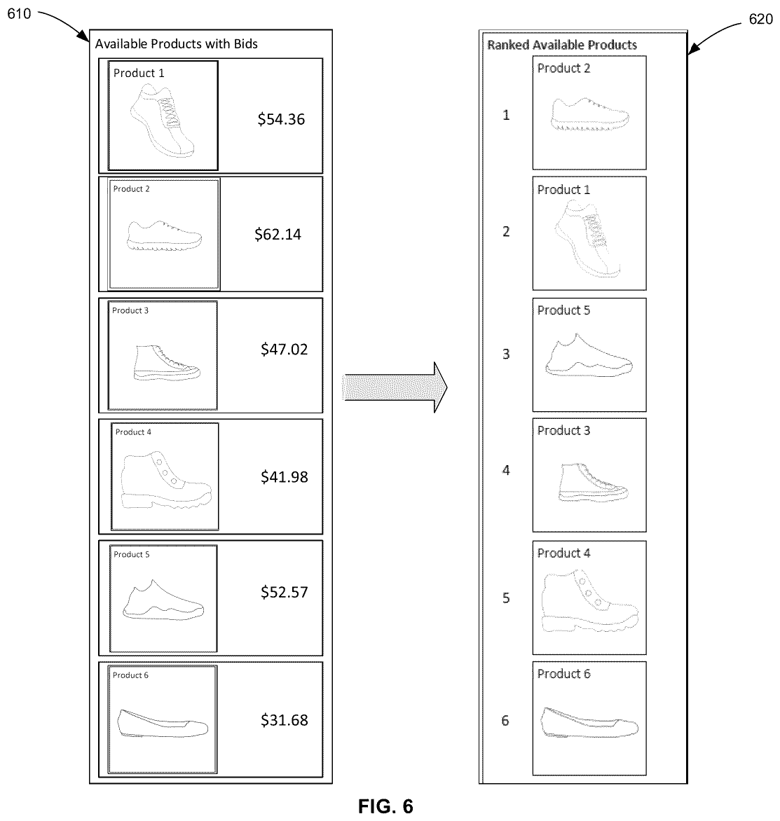

FIG. 6 illustrates an example in which the content from the available campaigns includes content depicting products 610, where the products have been ranked based on their generated bids. According to some examples, the content server may generate custom bids for each available campaign based on the campaign information. As described above, the bids are informed by the uncertainty measurement of the bidding model used.

The products may be ranked 620 based on their associated bids, wherein the bids are generated based at least partially on the uncertainty measurement. For example, where the bidding model includes a high degree of uncertainty, available campaigns including products matching the search query may have relatively lower bids as compared to bids that would be generated when bidding model has a low degree of uncertainty.

As shown by ranking 620, Products 1-6 have been ranked. In some examples, the products may be ranked based on bid amount. In some examples, the bids may be ranked based on additional factors such as relatedness to search query, demographics of user, and/or relatedness to previous searches of the user.

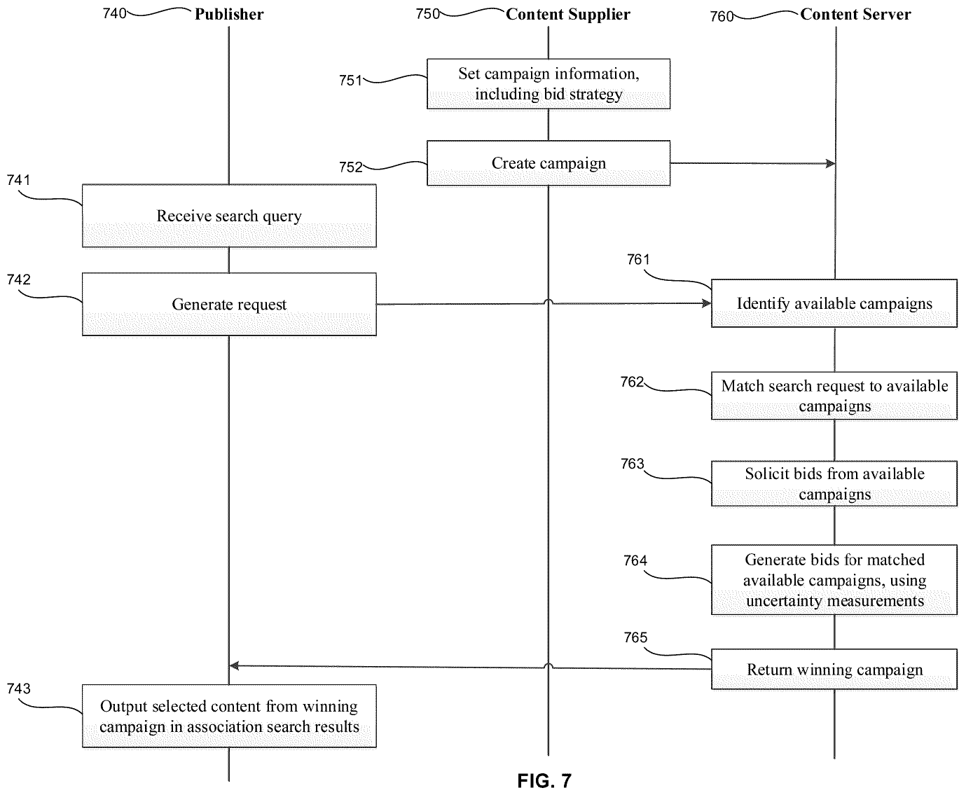

FIG. 7 is an example sequence diagram of operations that may occur among a publisher, a content supplier, and a content server. The following operations do not have to be performed in the precise order described below. Rather, various operations can be handled in a different order or simultaneously, and operations may be added or omitted.

In block 751, content supplier 750 may set campaign information regarding content, wherein the campaign information includes a bidding strategy. In block 752, the content supplier 750 may create one or more campaigns, based on the campaign information in block 751. For example, the content supplier 750 may select one or more products from a publisher's 740 catalog. The publisher's catalog may include a plurality of products that can be sponsored by the content supplier 750. The content supplier 750 may submit the campaigns to the content server 760. The content server 760 may store the campaigns.

In block 741, the publisher 740 may receive a search query through the publisher's website or mobile application. The search query may be a user submitted search query for a particular product or type of product.

In block 742, in response to receiving the search request, the publisher 740 may transmit a content request to the content server 760 for content to be published in a reserved content space alongside the search results for “pink gym shoes.”

In block 761, the content server 760 may identify available campaigns being offered by the content supplier 750. The available campaigns may include content, such as content depicting products, available to be displayed in the reserved content space.

In block 762, the content server 760 may match the search query to the available campaigns. For example, the content server 760 may match the search query to campaigns including parameters relevant to the search query.

In some examples, as illustrated in block 763, the content server 760 may solicit bids from the available campaigns.

In block 764, the content server may generate bids based on the campaign information including the bidding strategy entered by the content suppliers 750. According to some examples, the bids may be generated automatically based on the bid strategy included in the campaigns. The bid strategy may define how bids should be generated and is at least partially based on an uncertainty measurement of the bidding model.

In block 765, after the conclusion of the bidding, the content server 760 may return the winning campaigns to the publisher 740.

In block 743, the publisher may output the content from the winning campaigns alongside the search results. An example output is shown in FIGS. 3A and 3B. In some examples, the system may provide feedback to the content supplier and/or the publisher. The feedback may offer suggestions to the content supplier to adjust the campaign information such as a different bidding strategy to better optimize the bids for the campaigns. Further, in some examples, the system may receive feedback as to which bids win the auction to inform future bidding models.

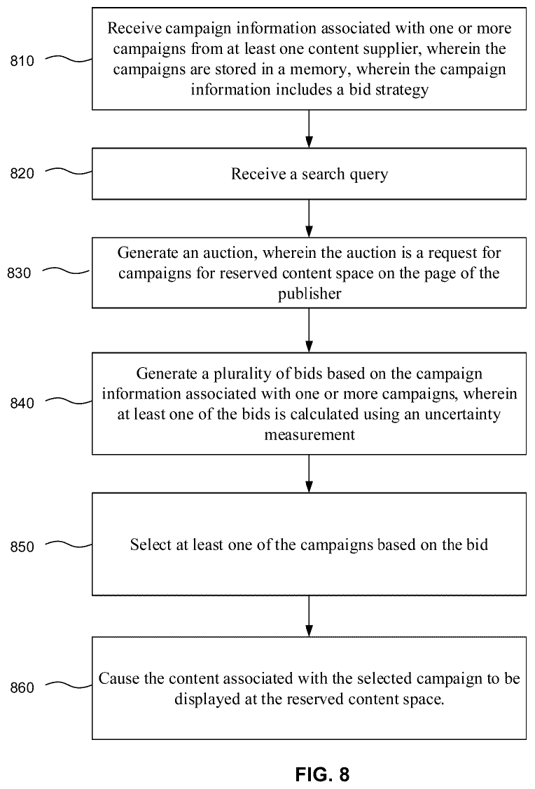

FIG. 8 illustrates an example method for identifying campaigns. The following operations do not have to be performed in the precise order described below. Rather, various operations can be handled in a different order or simultaneously, and operations may be added or omitted.

In block 810, the system may receive campaign information associated with one or more campaigns from content suppliers. The campaign information may include a selection of one or more products, keywords, etc. for each campaign. The products may include at least one of a type of product, a specific product, a type of service, or a specific service. Further, the campaign information may include a bid strategy.

In block 820, the system may receive a search query. The search query may be entered into the publisher's user interface by a user. The search query may determine what content is shown beside the search query's results, as the content server may match content associated with campaigns to the search query subject matter.

In block 830, the system may receive a request for a content for display on a content page of a publisher. The request may be associated with a search query or content filter received by the publisher. According to some examples, receiving the request for the content may further include receiving at least one search term or category associated with the search query or content filter on the content page of the publisher.

In block 840, the system may generate a plurality of bids based on the campaign information associated with one or more campaigns. In some examples, the bids may be given a numerical value. The system may use the numerical values to order or rank the bids from most profitable for the publisher to least profitable for the publisher. At least one of the bids may be calculated using an uncertainty measurement. The uncertainty measurement may be determined based on historical information regarding from the campaign's bids and auctions. In some examples, historical information from one or more similar campaigns may be utilized to determine uncertainty measurements. Various estimators may use this historical information to calculate the uncertainty measurement. In some examples, the estimator used to determine the uncertainty measurement may be quantile regression methods. In some examples, a trained machine learning model may generate the bids. According to some examples, the system may sort or rank the bids based on relatedness to the search query.

In block 850, the system may select at least one of the campaigns based on the bids. The system may provide for output on the content page of the publisher, based on the winning bid, content associated with the selected campaign.

In block 860, the system may cause the content associated with the selected campaign to be displayed at the reserved content space.

The technical advantages of incorporating the uncertainty measurement in the bidding system include optimizing bidding strategies based on campaign information to generate customized bids for auction. For example, the system may reduce the value of bids in proportion to uncertainty with the intention of rebalancing revenue with more certain predictions For example, bids with greater uncertainty may have a lower value bid as compared to bids with lower uncertainty, which may have a higher value bid. By adjusting the bids in proportion to the uncertainty, the likelihood of irrelevant or unwanted content, or content having a low likelihood of success with the target audience, is prevented from being provided for output. This reduces computational and network overhead by not having to replace content with content that is more relevant, wanted, or has a likelihood of success with the target audience.

Further, by evaluating the uncertainty of a bidding model based on a variance within one campaign to a performance of each predictor, computer resources are reduced. For example, the use of quantile regression to determine the uncertainty measurement reduces computational resources, relative to other modeling techniques for DNNs. Because quantile regression uses less computational intensity, the content server may free some computational space by not having to store inaccurate estimations of expected utility of content between auctions.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

Although the subject matter herein has been described with reference to particular examples, it is to be understood that these examples are merely illustrative of the principles and applications of the present technology. It is therefore to be understood that numerous modifications may be made to the illustrative examples and that other arrangements may be devised without departing from the spirit and scope of the subject matter as defined by the appended claims.

1. A method, comprising:
receiving, by one or more processors, campaign information associated with one or more campaigns from at least one content supplier, wherein the campaigns are stored in a memory, wherein the campaign information includes a bid strategy;
generating, by one or more processors in response to receiving a search query, an auction, wherein the auction is a request for bids for a reserved content space on a content page of a publisher;
generating, by one or more processors, a plurality of bids based on the campaign information associated with one or more campaigns, wherein at least one of the bids is calculated using an uncertainty measurement;
selecting, by one or more processors based on the plurality of bids, at least one of the campaigns based on the bid; and
causing content associated with the selected at least one of the campaigns to be displayed at the reserved content space.

2. The method of claim 1, wherein generating the plurality of bids further comprises utilizing at least one bidding model.

3. The method of claim 1, wherein the uncertainty measurement is based on at least one of:
historical information of at least one bidding model, or
a function of a likelihood of success of a bid.

4. The method of claim 1, wherein the uncertainty measurement is determined using at least one of quantile regression methods, ensembles, dropout, or Bayesian methods.

5. The method of claim 1, wherein the uncertainty measurement is calculated using a trained neural network, wherein the trained neural network is trained using data from previous outcomes.

6. The method of claim 1, wherein receiving the plurality of bids is further based on the search query, such that at least one bid for the auction is related to the search query.

7. The method of claim 1, further comprising providing feedback to the content supplier comprising a metric of effectiveness of the bidding strategy for the selected at least one campaign.

8. The method of claim 1, further comprising
generating, by one or more processors, keywords associated with a subject of the search query; and
selecting, by one or more processors, one or more campaigns associated with the search query keywords.

9. The method of claim 1, wherein the search query is received from an end user, and selecting the one of the campaigns is based on historical interactions of the end user.

10. The method of claim 1, further comprising:
determining, by one or more processors, a relative degree of the uncertainty measurement; and
wherein generating the plurality of bids is based on the relative degree of uncertainty measurement.

11. A system, comprising:
memory storing one or more campaigns from a content supplier, the campaigns having associated campaign information including a bidding strategy;
one or more processors, the one or more processors configured to:
generate, in response to receiving a search query, a request for bids for a reserved content space on a content page of a publisher;
generate a plurality of bids based on the campaign information, wherein at least one of the bids is calculated using an uncertainty measurement;
select, based on the plurality of bids, at least one campaign based on the plurality of bids; and
cause content associated with the selected at least one campaign to be displayed at the reserved content space.

12. The system of claim 11, wherein when generating the plurality of bids, the one or more processors are further configured to utilize at least one bidding model, wherein the uncertainty measurement is based on at least one of:
historical information of at least one bidding model, or
a function of a likelihood of success of a bid.

13. The system of claim 11, wherein the uncertainty measurement is determined using at least one of quantile regression methods, ensembles, dropout, or Bayesian methods.

14. The system of claim 11, wherein the uncertainty measurement is calculated using a trained neural network, wherein the trained neural network is trained using data from previous outcomes.

15. The system of claim 11, wherein generating the plurality of bids is further based on the search query, such that at least one bid for the auction is related to the search query.

16. The system of claim 11, wherein the one or more processors are further configured to provide feedback to the content supplier regarding the comprising a metric of effectiveness of the bidding strategy.

17. The system of claim 11, wherein the one or more processors are further configured to
generate keywords associated with a subject of the search query; and
select one or more campaigns associated with the search query keywords.

18. The system of claim 11, wherein the search query is received from an end user, and selecting at least one of the campaigns is based on historical interactions of the end user.

19. The system of claim 11, wherein the one of more processors are further configured to:
determine a relative degree of the uncertainty measurement; and
wherein generating the plurality of bids is based on the uncertainty measurement.

20. A non-transitory computer-readable medium carrying instructions that, when executed by one or more processors, cause the one or more processors to carry out the method of:
receiving campaign information associated with one or more campaigns from at least one content supplier, wherein the campaigns are stored in a memory, wherein the campaign information includes a bid strategy;
generating, in response to receiving a search query, an auction, wherein the auction is a request for bids for a reserved content space on a content page of a publisher;
generating a plurality of bids based on the campaign information associated with one or more campaigns, wherein at least one of the bids is calculated using an uncertainty measurement;
selecting, based on the plurality of bids, at least one of the campaigns based on the bid; and
causing content associated with the selected at least one campaign to be displayed at the reserved content space.
